(19) United States
(12) Patent Application Publication
(10) Pub. No.: US 2017/0243672 A1
(43) Pub. Date: Aug. 24, 2017

(54) COMPOSITE TRANSPARENT CONDUCTING FILMS AND METHODS FOR PRODUCTION THEREOF

(71) Applicant: Purdue Research Foundation, West Lafayette, IN (US)

(72) Inventors: Gary J. Cheng, West Lafayette, IN (US); Qiong Nian, West Lafayette, IN (US); Michael Callahan, Hanson, MA (US); John S. Bailey, Temple, NH (US)

(21) Appl. No.: 15/054,568

(22) Filed: Feb. 26, 2016

Related U.S. Application Data
(60) Provisional application No. 62/121,812, filed on Feb. 27, 2015.
(60) Provisional application No. 62/142,879, filed on Apr. 3, 2015.

(51) Int. Cl. H01B 5/14; G06F 3/044; C09D 5/24; C09D 11/52; H01B 1/08; H01B 13/00

(52) U.S. Cl. CPC H01B 5/14; H01B 1/08; H01B 13/0016; H01B 13/003; C09D 5/24; C09D 11/52; G06F 3/044; G06F 2203/04103

(57) ABSTRACT

A composite transparent conducting film (TCF) on a substrate that includes a first region extending to a first depth of the TCF and having a higher density (lower porosity) than a second region of the TCF located at a different depth of the TCF. A method of forming the composite TCF includes applying a transparent conducting layer onto a substrate or onto a second layer previously formed on the substrate, and rapidly heating the transparent conducting layer resulting in a first region extending to a first depth of the transparent conducting layer that is at least partially melted and of a higher density (lower porosity) than a second region located at a different depth of the transparent conducting layer that is not melted, thereby forming a composite TCF that has a change of porosity in a thickness direction of the composite TCF.

### CROSS REFERENCE TO RELATED APPLICATIONS

This application claims the benefit of U.S. Provisional Application No. 62/121,812, filed Feb. 27, 2015, and U.S. Provisional Application No. 62/142,879, filed Apr. 3, 2015, the contents of which are incorporated herein by reference.

### STATEMENT REGARDING FEDERALLY SPONSORED RESEARCH

This invention was made with government support under Contract No. 1248886 awarded by the National Science Foundation. The government has certain rights in the invention.

### BACKGROUND OF THE INVENTION

The present invention generally relates to materials and processes for their deposition. The invention particularly relates to transparent conducting films, their deposition, and post-deposition treatments.

Projective capacitance (P-cap) is currently the dominant technology facilitating the touch panel (also known as touchscreen) market, and is forecast to be used by 97% of the market in 2016. This technology employs a grid of receive and transmit lines to create a pattern of active or touch electrodes that are able to detect a capacitance change when a finger or multiple fingers nears a touch panel. In order to produce a sufficiently strong capacitance field, the material used for the grid lines should be highly electrically conductive. The grid material should also be optically transparent so as not to unacceptably degrade the image coming from a display module. Materials having such properties are commonly referred to as transparent conducting films (TCFs). Transparent conducting oxides (TCOs) are notable TCF materials as being both electrically conducting and transparent in the visible light spectrum (400-700 nm). Indium tin oxide (ITO) is an example of a TCO material that is widely used by industry to produce projective capacitance grid lines due to its superior electrical and optical properties. Other TCO materials such as aluminum-doped zinc oxide (AZO), gallium-doped zinc oxide (GZO), and others have been considered as a replacement for ITO, but have as yet been unable to outperform ITO on its combination of high optical transparency and electrical conductivity. For use as projective capacitance gird lines, ITO is deposited and patterned on an electrically insulating substrate, either glass or a flexible polymer film, typically polyethylene terephthalate (PET). Industrial touch panel manufacturers typically deposit ITO on large glass sheets or flexible roll-to-roll PET films using large area vacuum sputtering that allows for scalability. The sputtered ITO film is then processed by photolithography to pattern the deposited blanket film into projective capacitance grid lines and patterns of touch electrodes. A generic term “touch electrodes” will be used herein to refer to active electrodes of touch panels, including active electrodes formed of TCOs such as ITO.

Semiconductor TCO materials such as ITO, AZO, GZO, and others, although highly transparent in the visible spectrum (typically >85% for touch electrodes), nonetheless have enough visible light absorption to impact display parameters such as visual appearance and battery life. Thus it is desirable to make these films as thin as possible to keep optical absorption at a minimum. Unfortunately electrical conductivity is reduced as the thickness of the TCO layer is reduced. Thus films are configured to balance high transparency and low sheet resistance. To compare TCFs, industry has used the term “figure of merit” (FOM) as a quantitative measure of the ratio of the electrical conductivity of a film to the visible transmittance of the film. There are many definitions of FOM for TCF touch electrodes in the art, but in general a high figure of merit is desirable for TCF touch electrodes. One of the most common definitions of FOM cited by industry is T¹⁰/R_{S}, where T is the transmittance of the sample in the visible spectrum (400-700 nm), typically measured at 550 nm, and R_{S} is the sheet resistance, defined by the direct current D.C. conductivity multiplied by the depth of the film. Sputtered ITO films typically can have a FOM as defined from 0.001 to 0.05 inverse ohms (Ω⁻¹) depending on the thickness of the film. For practical touch panel applications, TCFs should have at least a sheet resistance of about 500 ohm-square or less and a transmittance in the visible spectrum of about 85% or greater.

The flat panel display industry typically produces ITO films at thicknesses of about 50-200 nm with sheet resistances (the standard measurement for electrical conductivity in touch panel and other semiconductor electrode applications) of about 50-120 ohms-square on glass and about 100-250 ohms-square on polymer PET substrates with optical transparencies of 85-95% in the visible region. Generally, thinner films have higher transparency and a lower sheet resistance than the thicker films, as sheet resistance and optical transparency have an inverse or negative effect on one another as previously discussed. Industry rarely produces ITO film for touch panel applications thicker than 300 nm due to low optical transmittance of thicker films and high production costs due to lower production throughput for thicker films as sputtering and film etching in photolithography are slow. Sputter deposition also uses expensive vacuum chambers and photolithography is even more expensive with large sophisticated optics and multiple individual process steps. Therefore, there is an ongoing need to provide improved production methods for TCFs that have higher throughputs, eliminate vacuum deposition, and have lower overall production costs to produce high FOM (>0.001 Ω⁻¹ using T¹⁰/RS) TCFs having thicknesses of less than 500 nm and preferably less than 200 nm.

There have been considerable efforts directed to large area solution deposition processes such as printing and spray coating of nanoparticles or precursor solutions of TCOs combined with conventional annealing as a replacement for sputtering techniques. Printed TCO nanoparticle layers have not demonstrated sheet resistances lower than 500 ohms-square for thicknesses less than 300 nm (less than 10⁻³ ohms-cm electrical conductivity), which is desired for current P-cap touch panel technology. Other solution deposition techniques such as spray coating are not uniform enough to yield visually pleasing films and typically require heating of the substrate at high temperature to produce low conductivity and high electronic mobility. There has been some success in the art in spin coating ITO films with high FOMs, but spin coating is not a scalable high-throughput process for touch panels and other applications that benefit from large area deposition methods. Additionally, spray coating and spin coating are not direct print technologies and thus expensive photolithography techniques would still have to be employed to pattern the deposited film.

Laser crystallization has proven to be beneficial in increasing the electron mobility and optical transparency and decreasing the sheet resistance of TCO layers, as evidenced by U.S. Patent Application Publication No. US 20130075377 to Cheng et al., which describes using pulse laser deposition (PLD) to deposit an AZO layer on a thin intrinsic zinc oxide (i-ZnO) buffer layer. Cheng et al. disclose that electrical and optical properties of an AZO layer improve after UV irradiation and crystallization of the AZO by melting a majority of the nanoparticles in the AZO film. While not intending to promote any particular interpretation, it appears that Pan et al., “Fiber Laser Annealing of Indium-tin-oxide Nanoparticles for Large Area Transparent Conductive Layers and Optical Film Characterization,” Applied Physics A (2011) 104:29-38, reports similar results for infrared (IR) laser treatment of spin-coated ITO nanoparticle films over 500 nm thick.

It is also known generally in the art that buffer layers can enhance the properties of electronic, opto-electronic, and semiconductor materials. Cheng et al. discloses i-ZnO buffer layers were produced by a PLD vacuum process which is expensive and has slow throughput. Cheng et al. does not discuss the properties of the i-ZnO buffer layer to include structural morphology, porosity and crystallographic orientation or how to optimize the buffer layer for subsequent laser crystallization of the AZO layer. Pan et al. used spin-coated ITO nanoparticle films as a template for laser crystallization and made no mention of buffer layers or whether the ITO spin-coated nanoparticles were melted or not by IR laser heating. Other prior art has produced buffer layers by printing for subsequent printing of TCO layers, but the FOM of the printed TCO film on printed buffer layers were substantially lower than the corresponding sputter films of the same material and substrate combinations (i.e., an ITO printed film on a printed buffer layer on glass vs. an ITO sputtered film on glass) particularly for direct print methods of patterned films such as inkjet and gravure. To summarize, there has been limited success in the prior art on using printed buffer layers to improve the FOM of printed TCO films.

The prior art of direct printed patterned TCO films in laser crystallized printed films are believed to have several limitations which to date have prevented adoption into large display manufacturing processes. These limitations include: (i) the inability to reliably print TCO films and any underlying buffer layers whose total thickness is less than 500 nm on large meter-sized glass and polymer substrates with high electrical, optical, and structural uniformity by direct print technologies such as ink jet printing, flexography, and gravure; (ii) the inability to produce low sheet resistance TCO films that are less than 100 ohms-square in direct printed pattern TCO films less than 500 nm thick; (iii) the inability to produce printed TCO films without indium that are visibly pleasing in appearance for display applications including touch panels and also have a high FOM (indium is an expensive and rare material that industry desires to replace if a suitable replacement can be found); (iv) the inability to avoid long range millimeter to centimeter delamination, cracking, or strain in TCO films during post-annealing processes; and (v) the requirement of using expensive vacuum processing steps to produce buffer layers and optical layers for the printed TCO films.

In the last several years, the touch panel manufacturers have developed techniques to construct transmit (Tx) and receive (Rx) touch electrodes directly on the cover glass of a display module to lower cost and reduce thickness and weight of touch-enabled devices. This configuration is called the one-glass solution (OGS). Other names are touch on cover (TOC), touch on lens (TOL) and 02 configuration (both Tx and Rx ITO patterns on one sheet of glass). Formation and photolithography of ITO on PET flexible substrates (film) in a roll to roll configuration has also been recently developed. The ITO on PET is then laminated to the cover glass and the display. This configuration is typically called ITO film, discrete film, film, add-on type, GF2, G IF, and GFF. Also touch electrodes are directly deposited on top of the upper display glass (color filter glass for LCD displays or encapsulation glass for AMOLED displays) which is referred to as an On Cell configuration. One or more of the touch electrodes can also be formed within the display module itself (In cell). The Tx and Rx touch electrodes can also be formed on a single surface or substrate either with jumpers and/or highly electrically insulating films between touch electrodes or in a “true single layer” configuration. There are also many hybrid configurations where the Tx touch electrode is formed on a different substrate than the Rx touch electrodes. These terms and concepts are summarized herein and the inventive art discussed herein can be used in different embodiments for most of the touch electrode configurations known in the art.

Thus, it is highly desirable to have a method of producing TCFs, including but not limited to TCOs, capable of having relatively high FOMs. It would be particularly beneficial if such a method could produce TCFs and buffer layers for those films with total thicknesses less than 500 nm, sheet resistances of less than 100 ohms-square, high average optical transparencies in the visible of greater than 80%, and/or FOMs greater than 0.001 Ω⁻¹, and yield TCFs that are also visibly pleasing with few defects noticeable to the naked eye so as to be suitable for use in display applications including touch panels.

### BRIEF DESCRIPTION OF THE INVENTION

The present invention provides a composite transparent conducting film (TCF) having a particle density gradient in a thickness direction of the TCF. The gradient is comprised of a change in particle density in the thickness direction of the transparent conducting film from a denser (less porous) structure with a higher electrical conductivity and lower optical transmittance in the visible spectrum to a less dense (more porous) structure with a lower electrical conductivity and a higher optical transmittance in the visible spectrum. The present invention includes a method of producing the composite transparent conducting film including a combination of printing and sub second heating of the transparent conducting film.

According to one aspect of the invention, a method of forming a composite transparent conducting film on a substrate includes applying a transparent conducting layer onto a substrate or onto a layer previously formed on the substrate, and rapidly heating the transparent conducting layer resulting in a first region extending to a first depth of the transparent conducting layer that is at least partially melted and of a higher density (lower porosity) than a second region of the transparent conducting film located at a different depth of the transparent conducting layer that is not melted, thereby forming a composite transparent conducting film that has a change of porosity in a thickness direction of the film.

According to another aspect of the invention, a composite transparent conducting film includes a substrate and a transparent conducting film on the substrate or on a film located on the substrate, wherein the transparent conducting film has a first region extending to a first depth of the transparent conducting film having a higher density (lower porosity) than a second region of the transparent conducting film located at a different depth of the transparent conducting film.

Technical effects of the film and method described above preferably include the ability to provide a TCF, for example, comprising a transparent conducting oxide (TCO) such as indium tin oxide (ITO), aluminum-doped zinc oxide (AZO), or gallium-doped zinc oxide (GZO), that has at least one of and more preferably all of the following characteristics: a total thicknesses of less than 500 nm, sheet resistances of less than 100 ohms-square, high optical transparencies in the visible range of greater than 80%, and FOMs greater than 0.001 Ω⁻¹.

Other aspects and advantages of this invention will be better appreciated from the following detailed description.

### BRIEF DESCRIPTION OF THE DRAWINGS

FIG. 1 is a flow diagram representing a method of manufacturing a transparent conducting film in accordance with certain aspects of the present invention.

FIG. 2A is a schematic representing a transparent conducting film having a two-layer microstructure and an optional buffer layer before laser heating.

FIG. 2B is a schematic representing a transparent conducting film having a three-layer microstructure formed from the two-layer structure of FIG. 2A after laser heating.

FIG. 3A represents SEM images of two spin-coated AZO layers before laser crystallization.

FIG. 3B represents SEM images of two two-layer composite AZO TCO films formed by laser crystallization of the spin-coated AZO layers of FIG. 3A.

FIG. 4 includes schematics, images, and graphs representing laser parameter influence on AZO film structures, properties, and electrical conductances. Image (a) schematically represents a laser crystallization process. Images (b)-(d) represent plane-view FESEM images of an AZO film: (b) before ultra-violet laser crystallization (UVLC); (c) during UVLC; and (d) after UVLC. Images (e) and (f) represent grain size distribution in an AZO film: (e) before UVLC; and (f) after UVLC. Image (g) represents pulse number dependence of Hall measurements employing UVLC with a laser fluence of 172 mJ cm⁻².

FIG. 5 is a graph representing the influence of laser parameters on AZO films, transmittance over wavelengths encompassing ultraviolet through infrared light, and sheet resistance after post-furnace anneal in a forming gas.

FIG. 6 is a graph representing low-haze laser-treated AZO samples compared to prior art transparent conducting films (TCFs).

### DETAILED DESCRIPTION OF THE INVENTION

A method is disclosed herein for laser crystallization of printed nanoparticle layers to form a composite stack of thin films (a “thin-film stack”) on a substrate. One or more layers are printed on a substrate and subsequently the layers are rapidly heated by a laser or other rapid heating method in such a manner that a thin-film stack is formed which has a characteristic change of morphological, structural, and/or chemical properties in a direction through the thickness/depth (“thickness direction”) of the thin-film stack which cannot be formed by near-equilibrium long-duration heating such as heating in an oven, furnace or other convective heating apparatus. The localized heating forms a thin-film stack with a beneficial particle density gradient throughout at least a portion of the thickness of the thin-film stack that could not be made by conventional convective heating. The film (or its precursor functional layer or layers) can be optionally heated at least once in a gaseous environment before, during, or after the rapid heating to form a highly conducting and visible optically transparent film ( ). This invention may be used with transparent conducting films including but not limited to ITO, AZO, GZO, and others as well with composite films which contain one or more transparent conducting films.

As used herein, a “substrate” is a support on which a material can be deposited.

As used herein, a “layer” is a material deposited upon a substrate, preferably printed, and that has yet been rapidly heated. Conventional long duration thermal heating (oven, furnace, or any other heating which occurs for longer than several seconds) may have been performed on the layer before the rapid heating.

As used herein, a “layer structure” is defined as multiple layers deposited on a substrate. Each layer of the layer structure may be functionally different to include having at least one different chemical, electrical, optical, structural, or other functional property.

As used herein, a “nanoparticle layer” is a layer consisting of solid nanoparticles that are less than one micrometer in at least one direction. The nanoparticles may be formed previously and dispersed in an ink which may then be printed and heated to remove the ink and form the nanoparticle layer. The nanoparticles may also be formed by a solvent or liquid ink that when heated forms solid nanoparticles from the liquid. Combinations of both methods may also be used to form a nanoparticle layer. The nanoparticles can have various levels of attachment as long as the nanoparticles are distinct by grain boundaries, voids, or other full or partial separation.

As used herein, a “sub-layer” or “partial-layer” is a portion of a layer. The sub-layer may be chemically or functionally different from other sub-layers or may be chemically or functionally similar to other sub-layers.

As used herein, “rapid thermal annealing” (or “RTA”) is heating that occurs for less than several seconds on at least one layer formed on a substrate. The rapid heating is typically initially caused by radiative processes (for example absorption of photons, X-rays, microwaves or other electromagnetic radiation) from an external heating source in at least a portion of at least one layer.

As used herein, “EMR” is an abbreviation for electromagnetic radiation. In the processes described herein, EMR may be absorbed into one or more layers causing the layer to increase in temperature. EMR may be produced from any source including but not limited to one or more lasers.

As used herein, “laser crystallization” (or “LC”) is a method by which at least a portion of layer or layer structure is heated causing increased densification and fusion of at least a portion of particles that make up the layer or layer structure. Preferably, at least a portion of the particles in one or more of the layers are melted or liquefied during LC. LC is referred to herein as a subset of RTA.

As used herein, a “film” is a layer which has gone through rapid thermal annealing (RTA), or is a layer of a layer structure having at least a portion of which that has gone through RTA.

As used herein, a “sub-film” or “partial-film” is a portion of a film. A sub-film may be chemically or functionally different from other sub-films within a film due to RTA performed on a corresponding layer, sub-layer, or layer structure.

As used herein, a “thin-film stack” is a combination of more than one film, where one or more of the films are configured to be functionally different than the other films after RTA.

As used herein, an “active sub-film” is a sub-film of a thin-film stack having the lowest sheet resistance relative to the other films and sub-films in the thin-film stack. Generally, the active sub-film is intended to generate a majority of the signal for a touch panel.

As used herein, a “passive sub-film” is a sub-film of a thin-film stack other than the active sub-film within the thin-film stack. In contrast to the active sub-film, the passive sub-film acts as a buffer film, nucleation film, ARC film, index matching film, and/or other functional film enabling a modified function or formation of the active sub-film.

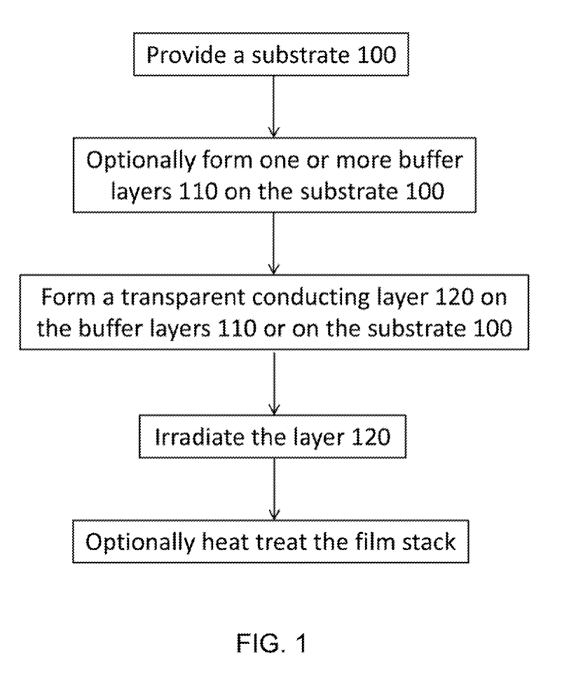

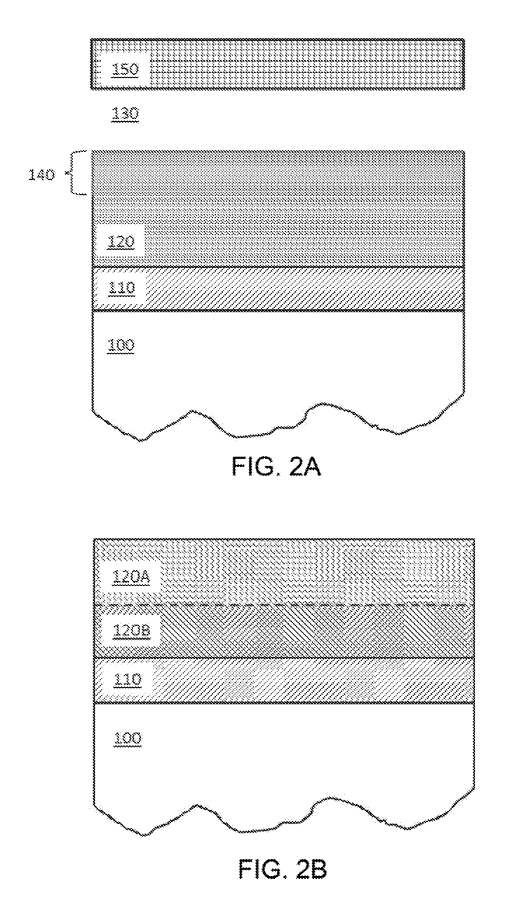

A nonlimiting method for producing a TCF is summarized in a flow chart in FIG. 1. FIGS. 2A and 2B are schematic representations of a layer structure (110,120) before laser crystallization (LC) (FIG. 2A) and a resulting composite TCF (120A-120B), in the form of a thin-film stack, after laser crystallization of the layer structure (110,120) (FIG. 2B). As summarized in FIG. 1, a substrate 100 is initially provided. One or more optional layers 110, for example, capable of being or yielding a buffer film, nucleation film, ARC film, index matching film, and/or other functional film, may be deposited on the substrate 100. A transparent conducting (TC) layer 120 is preferably formed by depositing an ink using a printing method and subsequently heating the ink in such a manner where the TC layer 120 will form on the substrate 100 and/or the surface of an optional layer 110. Electromagnetic radiation 130, preferable laser light, is then transmitted by a source 150 to the TC layer 120 and is absorbed in a first sub-layer 140 of the TC layer 120 that preferably defines the surface of the TC layer 120 and extends to a depth in the TC layer 120 which is less than the total thickness of the TC layer 120. The absorption of the electromagnetic radiation (EMR) 130 causes a temperature gradient in the thickness direction of the layer structure comprising the TC layer 120 and, if present, the layer 110. The temperature gradient in the thickness direction of the layer structure is formed in such a way that the topmost portion of the TC layer 120 is substantially melted, and the bottom portion of the TC layer 120 is substantially not melted thereby retaining or mostly retaining the original density and porosity that it had prior to LC.

FIG. 2B schematically represents the resulting composite TCF 120A-B as comprising a first region 120A that has relatively high density (low porosity) and a second region 120B that has a lower density (higher porosity than the first region 120A). The higher density region 120A has a greater electrical conductivity and a lower visible transmittance than the lower density region 120B, and as such the higher density region 120A may be referred to as the active sub-film 120A of the composite TCF 120A-B and the lower density region 120B may be referred to as a passive sub-film 120B of the composite TCF 120A-B. The active sub-film 120A may also have higher mobility and increased carrier concentration due to lower inter-grain defects between particles. The composite TCF 120A-B preferably has a higher figure of merit (FOM) of high electrical conductivity and high visible optical transparency as compared to other RTA and laser heating methods of printed TCOs known in the art. The composite TCF 120A-B may also have reduced thickness with a higher FOM than other printed TCOs known in the art. The active sub-film 120A may be transformed into an active functional device, for example, touch electrodes of a touch panel.

The TC layer 120 and any optional layers 110 in the layer structure (FIG. 2A) may be primarily formed by a printing technology, such as spin coating, spray coating, ink jet printing, and/or aerosol printing (non-contact print technologies) or gravure, offset gravure, micro-gravure, flexography, offset flexography, micro-flexography, slot die, and/or screen printing (contact print technologies). Although vacuum methods such as sputtering or evaporation could be used for some of the layers 110 and 120, particularly if the layers 110 and 120 are thin such as ARC layers or other optical enhancing layers such as index matching to include layers to make the touch electrode film less visible in appearance to the naked eye when integrated into a touch enabled display. It should be understood that FIGS. 2A and 2B represent only one possible enablement, and many different layers and configurations could be implemented depending on the requirements of performance and cost of the specific TCF electrode for a given application.

The layers 110 and 120 of the layer structure, particularly the TC layer 120, may be composed of nanoparticles. The TC layer 120 may be a contiguous layer in which the layer 120 is similar in composition, size, morphology, and chemical structure throughout its thickness, or the layer 120 could be a composite layer composed of different nanoparticle structures and compounds that may or may not be distributive uniformly in the layer 120. The layers 110 and 120 may be produced by one or more than one print processes such as ink jet, gravure, slot-die, or flexographic. The layers 110 and 120 may be composed of sub-layers (not shown) using multiple passes of a printing method to form a desired layer structure with a gradient in the thickness direction of the layer structure of nanoparticle size, morphology, chemical structure, particle porosity, or other functional differences.

The optional layer 110 may be a standard silicon oxide (SiO₂) or other anti-reflective coating (ARC) known in the art and may be deposited by vapor deposition or a printing technology. The optional layer (or layers or sub-layers) 110 in FIG. 2A may have several functions. For example, the optional layer 110 may be or act as a buffer layer that relieves thermal, strain, or other interface dynamics between adjacent layers or substrates surrounding the layer 110, thereby aiding in preventing or at least inhibiting the formation of cracks or other large defects in the TC layer 120 or overall thin-film stack formed by laser crystallization. The optional layer 110 may be an ARC having an index of refraction that would reduce optical reflection and/or reduce optical scattering in the thin-film stack thus improving the optical properties of the overall thin-film stack. The ARC layer index of refraction may be based on the bulk material properties if the density of the nanoparticles in about 95% or greater than that of the intrinsic bulk density, or a lower index of refraction may be designed if the density of the nanoparticles is less than about 95% than that of the intrinsic bulk density and any void space between the nanoparticles is smaller than about 50 nm to avoid optical scattering. This density and thickness of the ARC could be designed in such a way as to have a desired density after LC and further densification of the ARC layer, so as to have a specific index of refraction and thickness depending on the requirements to improve the overall transmittance of the thin-film stack using optical film theory for single layer and multilayer ARC known in the art. The optional layer 110 may be a thermal barrier layer which increases the thermal separation of at least one layer that is rapidly heated from at least one underlying layer or substrate whose functional properties will degrade if heated to an elevated temperature. The optional layer 110 may be a nucleation source where at least a portion of the larger particles in the optional layer 110 are large enough to act as positive nucleation source for smaller particles in the TC layer 120 during melting to further increase grain size during laser crystallization. Larger grains are known to improve electrical properties in some TCFs including TCOs. The optional layer 110 may be used to improve wetting properties and adhesion of printed ink by optimizing wetting angle and rheology of the optional layer's surface and the ink during printing.

An optional layer 110 or a sub-layer of the TC layer 120 can be purposely configured to have a lower carrier concentration (lower optical absorption) and tailored optical properties such as refractive index by varying the optional layer's or sub-layer's composition (i.e., non-AZO metal oxide with different refractive indexes) and the porosity and morphology (material that has porosity on a nanoscale is known to have different optical properties than the bulk material). This potentially would allow higher transmittance and lower haze (measurement of wide-angle scattering) with little or no additional cost. The optional layer 110 or any sub-layers may also be composed of the same material or compound but with different morphological properties from the TC layer 120. The optional layer 110 or any sub-layers may also both be different materials and/or compounds with different morphological and chemical structure properties.

An illustrative example of using an optional layer 110 is as follows: a SiO₂ nanoparticle layer would be printed on top of a glass substrate (e.g., 100 in FIG. 2A), followed by printing an aluminum-doped zinc oxide (AZO) nanoparticle (NP) layer as a TC layer 120 on top of the SiO₂-containing optional layer 110. Laser light would then be directed onto the composite SiO₂/AZO layer structure. The laser light would be absorbed into at least a portion of the AZO nanoparticles in the TC layer 120 causing the TC layer 120 to be mostly but not completely melted. Some of the SiO₂ within the optional layer 110 may or may not be melted through heat conduction and fluid convection from the TC layer 120 either through melting of solid grain densification from annealing. The resulting thin-film stack would have a low density SiO₂ buffer film (110 in FIG. 2B) adjacent to the glass substrate 100 with an index of refraction slightly lower than a fully densified bulk layer of SiO₂. Some of the SiO₂ may chemically combine with the AZO in the TC layer 120 to form a zinc silicate with a beneficial index of refraction for improved light transmittance of visible light. The resulting thin-film stack further comprises the active sub-film 120A formed in the TC layer 120. The SiO₂ buffer film 110 near the glass substrate 100 would preferably be the least dense film, followed by the zinc silicate sub-film (if present), and the active sub-film 120A would be the densest. In such a way, a beneficial thin-film stack for touch electrodes could be formed that has low optical reflection and low optical haze in the visible spectrum resulting from the lower refractive index in the less dense films having values between that of the glass substrate and AZO film, preferably with locations and thicknesses thereof controlled to increase optical transmittance and reduce haze. The thin-film stack would also preferably have high electrical properties such as high mobility, high electrical conductivity, and high electron carrier density. This would likely result in a high FOM thin-film stack for a touch electrode.

The buffer layers, ARC layers or sub-layers may be other potential ARC materials such as Al₂O₃, spinel compounds such as MgAl₂O₄ or ZnAl₂O₄, various halides such as MgFI, and many other compounds which give high figure of merits when combined with TCO layers and subsequently treated with an EMR for a gradient density thin-film stack. The TC layer 120 and TCF 120A-B may be aluminum-doped zinc oxide (AZO), gallium-doped zinc oxide (GZO), boron-doped zinc oxide (BZO), tin oxide, indium tin oxide (ITO), combinations such as indium tin zinc oxide (ITZO), or any other TCO or TCF material.

The absorption of the electromagnetic radiation (EMR) 130 preferably causes a temperature gradient in the thickness direction of the TC layer 120, any optional layers 110 and the substrate 100. The temperature gradient in the layers 110 and 120 is formed in such a way that the first sub-layer 140 of the TC layer 120 is substantially melted, and the region or sub-layer of the TC layer 120 beneath the first sub-layer 140 is substantially not melted. This is primarily done by configuring the conditions such that the majority of the electromagnetic radiation 130 is absorbed in the first sub-layer 140 of the TC layer 120. Heat during LC may be transferred to the rest of the TC layer 120, any optional layers 110, and the substrate 100 primarily by thermal conduction. Additional heat may be transferred into the TC layer 120 and any optional layers 110 and the substrate 100 by thermal conduction of any solids or molten fluid and convection of any hot melted fluid in the layer structure.

The substrate 100 is preferably heated much less than the first sub-layer 140 and less than any optional layers 110 during LC thus avoiding degradation or damage of the substrate 100. Melting the complete layer structure may damage or degrade a functional property of the underlying substrate 100 as the substrate 100 may be heated above a critical temperature. For example, display glass in production typically is not heated above 400 Celsius in manufacturing and PET degrades around 150 Celsius. The thicknesses, morphology, and thermal properties of the layers 110 and 120 may be designed to limit the substrate temperature to below a specific value during LC. One example of this is to provide a relatively thick overall layer structure for substrates with low decomposition temperatures, such as PET, in order to increase an overall thermal capacity of the layer structure.

It is preferred that the electromagnetic radiation 130 has a high absorption coefficient in the TC layer 120 but also has an absorption depth that does not substantially penetrate through the whole TC layer 120 but instead primarily penetrates and is absorbed in the first sub-layer 140 of the TC layer 120. If the electromagnetic radiation 130 is substantially absorbed into the TC sub-layer beneath the first sub-layer 140 at such an energy to melt the whole TC layer 120, the whole layer structure may melt resulting in loss or reduction of the beneficial properties of the optional layers 110 and the non-melted or substantially less melted passive TC sub-film 120B previously discussed.

As previously noted, the electromagnetic radiation 130 may be any one of a variety of radiative processes, including laser beams, photons, X-rays, and microwaves, with laser beams believed to be preferred. Different lasers may be configured in different ways. For example, an excimer 248 nm UV laser which has a fairly low absorption depth of 50 nanometers and short pulse width of around 25 nanometers may be used to form an active sub-film 120A by melting a few hundred nanometers in depth. In contrast, an IR CW laser with an absorption depth of greater than ten times that of an excimer 248 nm UV laser and a heating duration in the high microseconds may form an active sub-film 120A by melting over 500 nm in depth depending on other conditions.

Methods as described herein preferably configure the type of laser or EMR and its physical interaction with the layers 110 and 120 in such a way as to cause a thermal gradient in the thickness direction of the layer structure causing the first sub-layer 140 to be mostly or completely melted and other sub-layers and layers 110 of the layer structure to be only slightly melted or not melted at all. This is primarily done by designing the thickness, morphology and porosity of the layers 110 and 120 to include any printed layers, the size and morphology of the nanoparticles comprising the layers, and the heat transfer characteristics of the layers, in conjunction with a specific absorption of electromagnetic radiation 130 into at least a portion of one or more of the layers 110 and 120. One may use heat transfer (HT)/electromagnetic (EM) models to determine heating parameters to produce a desired temperature gradient over a time constant in the thickness direction of a layer structure from an uppermost surface of the layer structure to the substrate 100 to produce a desired structure density gradient in the resulting composite TCF 120A-120B.

Multiple laser sources may be used to further control the temperature gradient in the thin-film stack of the composite TCF 120A-120B. The laser parameters (for example, CW or pulse, number of pulses, irradiation time, pulse rate, number of pulses, laser energy, etc.) may be tailored to generate a relatively sharp density gradient or a more gradual density gradient. The process may be repeated multiple times to produce more than one density gradient in the thickness direction of the thin-film stack.

In the specific enablement of FIG. 2B, the TC sub-layer beneath the first sub-layer 140 could be transformed after laser crystallization (LC) to a passive sub-film 120B that would have a lower density (higher porosity) then the active sub-film 120A. As such, the active sub-film 120A could perform as the functional touch electrode film after laser crystallization as it would have a much lower sheet resistance than the passive sub-film 120B. In this example, the laser or other electromagnetic radiation (EMR) could be pulsed or continuous as long as the radiation concentration and absorption allows for a substantial temperature gradient through the thicknesses of the layers 110 and 120 and the substrate 100. A substantial temperature gradient could be defined as more than 200° C., preferably more than 1000° C. between the uppermost (outer) surface of the active sub-film 120A and the uppermost surface of the substrate 100 as represented in FIG. 2B.

Forming a temperature gradient through the thicknesses of the layer structure during LC or crystallization by other EMR causes a corresponding gradient of crystallization and thus nanoparticle porosity to form in each layer 110 and 120 and in some cases at different depths within an individual layer 110 or 120. Specifically the thicknesses of the layer structure would have varying degrees of porosity depending on the laser parameters used to process the layer 110 or 120; wherein a layer 110 or 120 or portion of a layer 110 or 120 that is rapidly heated and/or melted to a high degree may have a lower porosity and higher density compared to a layer 110 or 120 or portion of a layer 110 or 120 melted and/or heated to a lower degree. RTA by LC as described herein enables a dense nanoparticle composite TCF 120A-120B or sub-film 120A with larger grain size and sharper grain boundaries that is less than 500 nm thick to be formed. The thin-film stack of the composite TCF 120A-120B may have a density gradient in the thickness direction of the thin-film stack as discussed above.

In order to have high electrical conductivity and corresponding low sheet resistance, the composite TCF 120A-120B or sub-film 120A may be processed in vacuum, an inert atmosphere with no oxygen or water vapor, or an oxygen reduced atmosphere and heated for a period of time that exceeds several seconds. Heating TCO films in an oxygen or water containing environment is known to increase the sheet resistance of such samples and heating in an atmosphere without water and oxygen has the opposite effect. The heating may be in low oxygen and water environment preferably may be done after the RTA but additionally can be done before and during the RTA. The heating is preferably performed so the underlying substrate 100 does not reach a critical temperature at which it would be damaged or degraded, typically 400-500° C. for glass and 100-200° C. for a polymer substrate such as PET. After annealing, LC-processed AZO films 120A-120B in a low oxygen environment a sheet resistance less than 100 ohms-square was able to be produced with sub 500 nm films.

Thus, it was discovered that even layers with the same chemical composition and structure can be made to have different functional properties by controlling the density and size of the particles within the layer through gradient depth heating and laser crystallization. For example, an AZO passive sub-film (120B) can have lower electrical mobility and conductivity and a lower index of refraction through a higher porosity of increased open void space between the nanoparticles within the passive sub-film than that of a low porosity, high density active sub-film (120A) where the printed nanoparticles where made to become larger, merge into other particles, and reduce void space through an increased degree of LC enabled by increased heating due to more UV light absorption in the active sub-film of the TCF film 120A-120B. The active sub-film may have high electrical mobility and conductivity, and also a higher index of refraction at or close to that of a bulk material. The combined high porosity passive sub-film and low porosity top AZO active sub-film would have improved overall functional properties than each layer alone. In this case the functional property could be defined as an enhanced figure of merit (FOM) as disclosed in the art for TCO or other transparent conductor (TC) films.

A benefit of certain embodiments as described herein is the ability to form a composite TCF which is less than 1000 nm, preferably less than 500 nm thick by industrial printing methods which would otherwise have difficulty producing such layers and also to produce TCFs less than 1000 nm, and preferably less than 500 nm thick with a higher figure of merit (preferably above 0.001 Ω⁻¹) of combined low sheet resistance and high optical transparency than those using equivalent TCF compounds employing traditional annealing techniques or other RTA methods known in the art. This is done through RTA to include laser crystallization (LC) in which a temperature gradient in the thickness direction of a TC layer 120 forms an active sub-film 120A of high electrical conductivity that has a thickness of less than 500 nm and preferable less than 200 nm with a sheet resistance of less than 1000 ohms-square and preferably less than 100 ohms-square and a passive sub-film 120B beneath the active sub-film 120A which has a higher sheet resistance but a higher visible optical transmittance. The difference in sheet resistance and visible optical transmittance in the active and passive sub-films 120A and 120B is due primarily to a difference in density between the two sub-films 120A and 120B caused by RTA to include laser crystallization. The composite TCF 120A-120B has a higher figure of merit (combined high electrical conductivity and optical transmittance in the visible spectrum) of printed films using other heating and crystallization methods known in the art.

It may be preferable to radiate the EMR 130 through the substrate 100 as opposed to directly irradiating the TC layer 120 and any optional layers 110. In this configuration, the substrate 100 would preferably have to a high degree of transparency to the EMR 130 to prevent overheating and thus degradation of the substrate 100. In this embodiment the denser film or sub-film would be the sub-film 120B near the substrate 100 which would experience the maximum temperature increase during laser crystallization due to the increased absorption of the EMR 130. This may be beneficial for applications such as battery electrodes as a dense film is required near the outside of the electrode for high electrical conductivity and a more porous film or sub-film is required near the inside of the electrode for high storage capacity and reducing mechanical fatigue during cycling. This method could also be used for printable catalytic or battery/capacitor electrode applications thin-film stack where surface area may be adjusted for enhanced performance.

In some cases, the optional post-annealing treatment to make the material more electrically conducting may be reduced in temperature or eliminated entirely. For example laser crystallization or other EMR if performed in an inert or low oxygen environment may reduce the temperature or duration required for post-annealing in a low oxygen environment to achieve a desired electrical conductivity.

Nonlimiting embodiments of the invention will now be described in reference to experimental investigations leading up to the invention.

AZO precursor layers were formed on 2.5 cm² soda lime glass substrates. The glass substrates were cleaned with deionized water and isopropanol and dried using an air gun with purified air. The precursor solution consisted of semiconductor grade ethanol in which 0.4M of zinc acetate dihydrate [Zn(CH₃COO)₂.2H₂O] was dissolved. Aluminum nitrate hexahydrate [Al(NO₃)₃.6H₂O] was dissolved in an amount to yield 2% Al in relation to Zn. Diethanolamine [NH(CH₂CH₂OH)₂, DEA] was added at 1M ratio to the zinc acetate. The solution was heated to approximately 75° C. and stirred for 2 hours and allowed to cool to room temperature.

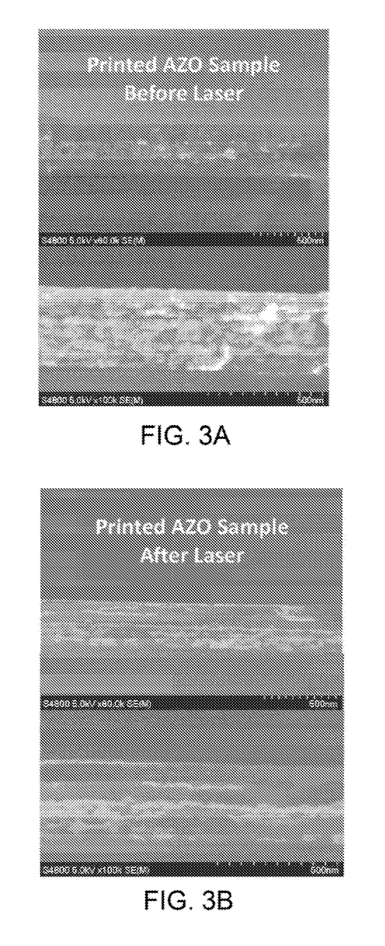

The glass substrates, one at a time, were then loaded into a Laurell WS650™ spin coater commercially available from Laurell Technologies Corporation® with an automatic dispenser unit. The precursor solution was dispensed onto each substrate eight successive times with the substrate spinning at 500 rpm for dispensation and then 3000 rpm for drying. After each layer dispensed, it was evaporated and annealed on a hot plate at approximately 475° C. to convert each precursor layer to AZO. After all eight layers were achieved, the substrates were placed in a tube furnace and heated in argon with 2% hydrogen gas for 2 hours. This resulted in an AZO layer that was 300 to 400 nm thick of a morphology and density as shown in the field emission scanning electron (FE-SEM) cross-sectioned pictured in FIG. 3A. It can be seen in FIG. 3A that the nanoparticles have a degree of separation that would increase the porosity of the film.

The spin-coated AZO layer was subsequently put into a nitrogen-purged chamber for the UV Laser crystallization. A KrF excimer laser (λ of 248 nm and τ of 25 ns) with repetition rate (RR) of 10 Hz was utilized. The laser beam was shaped to a square, top-hat profile (8×8 mm). In order to process large scale, the sample was placed on a motorized stage which enables translations along both X- and Y-axes. Laser intensities used in the crystallization experiments ranged from 130 to 210 mJ/cm². The laser pulse number (N) used ranged from 50 to 150, corresponding to a total laser irradiation time on the samples of 1.25 to 3.75 μs. Each laser pulse was able to introduce a localized high temperature field from photo energy absorption, because the band gap of AZO film is lower than the photo energy of excimer laser of 248 nm. In order to analyze the temperature history in the AZO film, COMSOL Multiphysics® modeling software was applied to simulate the laser energy absorption. An electromagnetic module (EM) was used to simulate laser irradiation, and a heat transfer module (HT) was used to describe the temperature increase in AZO nanoparticles during a single laser pulse delivery. The simulation calculated that a laser pulse increased the temperature of AZO nanoparticles to between 800 to 1500K in 60 ns depending on laser fluence of 120 to 200 mJ/cm², respectively. The temperature of the AZO nanoparticles would be lowered by thermal dissipation before subsequent laser pulse delivery. The simulated temperature of the glass substrate was below 400° C.

After the ultra-violet laser crystallization (UVLC), field emission scanning electron microscopy (FE-SEM) was used to observe the surface morphology and cross-section structure of some of the samples. For several samples processed by UVLC at a laser intensity of 173 mJ/cm², cross-sectioned FE-SEM images revealed a two-layer structure where in the top portion of the AZO film had a denser structure than the bottom portion of the AZO film as shown in FIG. 3B. The top region was formed through melting a majority of the nanoparticles, and the bottom region had significant densification through solid state annealing and grain growth. The bottom less-dense portion may have reduced the strain in the top layer thereby limiting cracking in the top layer.

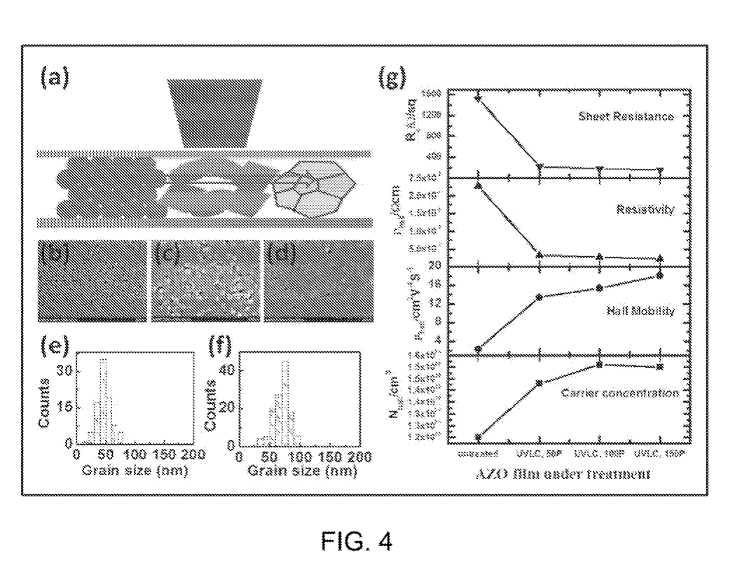

Image (a) in FIG. 4 is a schematic demonstrating the morphology of the nanoparticle TC layer before, during, and after UVLC. The top region of the film shows a higher density region and greater coalescence of the nanoparticles as shown by the top view planar FE-SEM images of the TC layer before, during, and after UVLC (images (b)-(d) in FIG. 4). The crystal size histograms can be measured from the top-view FE-SEM images as shown in image (e) and (f) in FIG. 4. The histograms show clear grain enlargement after UVLC. Electrical resistivity, carrier mobility and carrier concentration were measured by the Hall Effect with the Van der Pauw method. Image (g) in FIG. 4 shows improved electrical properties with increased pulse number.

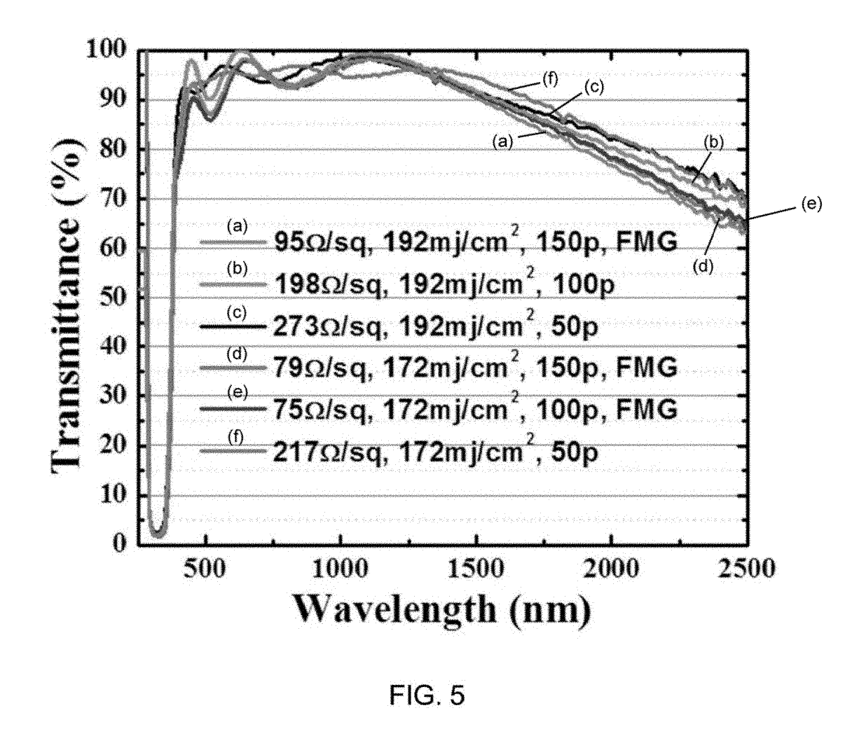

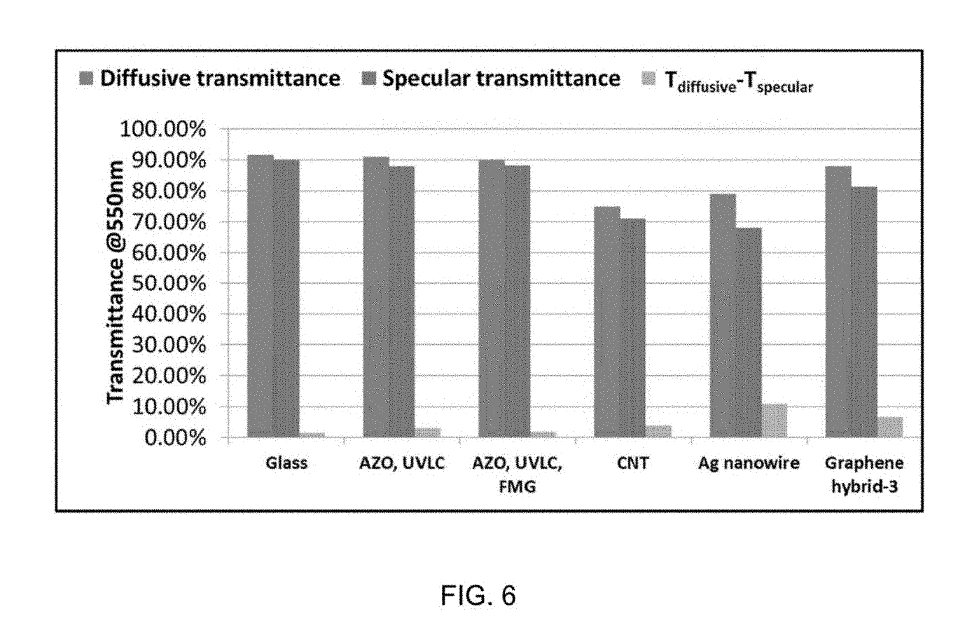

The lower porosity in the bottom region of the AZO film may have provided a lower index of refraction which acted as an anti-reflection coating thus increasing the overall transmittance in the sample and reducing optical scattering (T_{diffusive}−T_{specutar}) as measured in FIG. 5 and FIG. 6. Optical transmittance spectra and optical haze were measured by a Lambda 950™ spectrophotometer commercially available from PerkinElmer®. FIG. 5 represents the transmittance spectrum of a series of the tested samples in the wavelength range of 250-2500 nm (encompassing ultraviolet through infrared wavelengths) measured with a Cole-Parmer® glass reference substrate. All results met the requirements of touch panels for practical applications (Rs=500 ohm-square or less; T=85% or greater). FIG. 6 represents the diffusive and specular transmittance measured by UV-Vis-IR spectroscopy in transmittance mode. The diffusive and specular transmittance data were obtained at 550 nm wavelength as compared with other alternative transparent electrodes. It is can be seen that the scattering of the AZO film is about 2.7% after UV laser crystallization and about 1.8% after a forming gas annealing (FMG) process was performed, implying that the FMG process probably improved the film uniformness and homogeneity.

The electrical data of several AZO composite films processed by UVLC on soda lime glass substrates are shown below. A bi-region model was used to calculate N and R.

TABLE 1
Electrical Data UVLC AZO nanoparticles
layers using a bi-layer model.

| | | | Carrier | |
|---|---|---|---|---|
| | | | concentration | |
| | | Sheet Res. | (N) (cm⁻³) | Resistivity (R) |
| | Mobility | (ohms- | High mobility, | (ohms-cm) |
| Sample # | (cm²/Vs) | Square) | 150 nm top layer | 150 nm top layer |
| 12-2F11 | 15.5 | 95.3 | 2.82E+20 | 1.43E−03 |
| 12-2F14 | 17.2 | 79.8 | 3.04E+20 | 1.20E−03 |
| 12-2F15 | 15.3 | 75.4 | 3.61E+20 | 1.13E−03 |

In view of the above, it is believed that various enablements of the invention would allow for the production of a printed TC layer and subsequent laser treatment of the TC layer that produces touch electrode thin-film stacks having one or more of the following beneficial properties: (i) reduction in the formation of cracks or other large defects in a TCF thin-film or overall TCF stack through the reduction of mechanical strain in the one or more functional layers during heating, annealing, partial or full melting, and cooling occurring from any post-heating processes or any laser heating or crystallization; (ii) increased gram size in an upper portion of a layer during laser crystallization by nucleation of the upper layer during cooling on a printed lower buffer layer and/or underlying ARC layer which has a larger grain structure and/or better grain orientation than one or more upper layers; (iii) improved optical properties of the overall thin-film stack such as greater visible transmittance, reduced visible reflection, and/or reduced optical haze; (iv) improved electrical properties such as higher electrical conductivity (lower sheet resistance for given thickness), improved electrical mobility, and/or increased carrier concentration; and (v) increased thermal separation between the active TCF sub-film and any temperature sensitive substrate or any temperature sensitive underlying films during rapid heating of the TCF layer by absorption of light or other electromagnetic radiation (EMR) through the addition of a buffer layer or sub-layer between the TCF layer and the substrate or underlying film, thus reducing degradation of the substrate or underlying film.

While the invention has been described in terms of preferred/specific embodiments, it is apparent that other forms could be adopted by one skilled in the art. For example, the physical configuration of the layer structure, the transparent conducting thin-film stack, and/or the individual layers/films or sub-layers/sub-films could differ from that shown, and materials and processes/methods other than those noted could be used. Therefore, the scope of the invention is to be limited only by the following claims.

1. A method of forming a composite transparent conducting film on a substrate, the method comprising:
applying a transparent conducting layer onto the substrate or onto a second layer previously formed on the substrate; and
rapidly heating the transparent conducting layer resulting in a first region extending to a first depth of the transparent conducting layer that is at least partially melted and of a higher density (lower porosity) than a second region located at a different depth of the transparent conducting layer that is not melted, thereby forming a composite transparent conducting film that has a change of porosity in a thickness direction of the composite transparent conducting film.

2. The method of claim 1, wherein the first region has a thickness of less than 500 nm.

3. The method of claim 1, wherein the second region has a thickness of less than 500 nm.

4. The method of claim 1, wherein the first region has a higher electrical conductivity than the second region.

5. The method of claim 1, wherein the second region has a greater average optical transparency from 400-700 nm than the first region.

6. The method of claim 1, wherein the average optical haze from 400-700 nm in the composite transparent conducting film is less than 10%.

7. The method of claim 1, wherein the average optical transparency of the composite transparent conducting film is greater than 70%.

8. The method of claim 1, wherein the electrical sheet resistance of the composite transparent conducting film is less than 500 ohms-square.

9. The method of claim 1, wherein applying the transparent conducting layer includes applying more than one sub-layer.

10. The method of claim 9, wherein each sub-layer is formed from an aqueous precursor.

11. The method of claim 1, wherein the first region is formed by melting a plurality of particles in the first region.

12. The method of claim 1, wherein the substrate has a melting, transition (softening), or decomposition point lower than a melting, transition (softening), or decomposition point of the first region.

13. The method of claim 1, wherein the composite transparent conducting film fully or partially covers the substrate.

14. The method of claim 1, wherein the composite transparent conducting film is installed as an electrically conducting film in a touch panel.

15. The method of claim 1, further comprising:
applying the second layer on the substrate prior to applying the transparent conducting layer.

16. The method of claim 1, wherein the transparent conducting layer comprises AZO.

17. The method of claim 1, wherein the rapid heating is performed by applying electromagnetic radiation to the first region of the transparent conducting layer.

18. A composite transparent conducting film on a substrate, the composite transparent conducting film comprising:
a transparent conducting film on the substrate or on a film located on the substrate, a first region of the transparent conducting film extending to a first depth of the transparent conducting film and having a higher density (lower porosity) than a second region of the transparent conducting film located at a different depth of the transparent conducting film.

19. The composite transparent conducting film of claim 18, wherein the first and second regions each have a thickness of less than 500 nm.

20. The composite transparent conducting film of claim 18, wherein the transparent conducting film has a sheet resistance of 500 ohm-square or less and a transmittance of 80 percent or greater.
